(19) United States
(12) Patent Application Publication
(10) Pub. No.: US 2023/0147667 A1
(43) Pub. Date: May 11, 2023

(54) Hand-Held Power Tool comprising a Rechargeable Battery Pack Interface

(71) Applicant: Robert Bosch GmbH, Stuttgart (DE)

(72) Inventors: Patrick Heinen, Ludwigsburg (DE); Tobias Mangold, Murrhardt (DE); Mario Patzig, Bertsdorf-Hoernitz (DE)

(21) Appl. No.: 17/981,447

(22) Filed: Nov. 6, 2022

(30) Foreign Application Priority Data
Nov. 9, 2021 (DE) 10 2021 212 585.9

(51) Int. Cl. H01R 13/631; H01M 50/296; B25F 5/02; B25F 5/00

(52) U.S. Cl. CPC H01R 13/631; B25F 5/00; B25F 5/02; H01M 50/296

(57) ABSTRACT

A hand-held power tool includes a housing in which at least one drive motor for driving a tool holder is disposed. The hand-held power tool further includes a rechargeable battery pack interface for placing a rechargeable battery pack for supplying power to the drive motor. The rechargeable battery pack interface forms a primary support for the rechargeable battery pack. At least two intermediate elements for forming a secondary support are disposed on the housing in the region of the rechargeable battery pack interface. The at least two intermediate elements are disposed in such a way that a specified distance between the at least two intermediate elements and a rechargeable battery pack disposed at the rechargeable battery pack interface is provided which decreases in the direction of the at least two intermediate elements in the event of a shock pulse to the rechargeable battery pack and forms the secondary support when the rechargeable battery pack abuts the at least two intermediate elements.

This application claims priority under 35 U.S.C. § 119 to patent application no. DE 10 2021 212 585.9, filed on Nov. 9, 2021 in Germany, the disclosure of which is incorporated herein by reference in its entirety.

### BACKGROUND

The present disclosure relates to a hand-held power tool comprising a housing in which at least one drive motor for driving a tool holder is disposed and comprising a rechargeable battery pack interface for placing a rechargeable battery pack for supplying power to the drive motor, wherein the rechargeable battery pack interface forms a primary support for the rechargeable battery pack.

Such a rechargeable battery-operated hand-held power tool comprising a rechargeable battery pack interface for placing a rechargeable battery pack is known from the prior art. The rechargeable battery pack interface forms a primary support, which supports the rechargeable battery pack in the event of a shock pulse to the rechargeable battery pack, e.g., as a result of accidental dropping of the hand-held power tool.

### SUMMARY

The disclosure relates to a hand-held power tool comprising a housing in which at least one drive motor for driving a tool holder is disposed and comprising a rechargeable battery pack interface for placing a rechargeable battery pack for supplying power to the drive motor, wherein the rechargeable battery pack interface forms a primary support for the rechargeable battery pack. At least two intermediate elements for forming a secondary support are disposed on the housing in the region of the rechargeable battery pack interface, wherein the at least two intermediate elements are disposed in such a way that a specified distance between the at least two intermediate elements and a rechargeable battery pack disposed at the rechargeable battery pack interface is provided which decreases in the direction of the at least two intermediate elements in the event of a shock pulse to the rechargeable battery pack and forms the secondary support when the rechargeable battery pack abuts the at least two intermediate elements.

The disclosure thus makes it possible to provide a hand-held power tool in which the at least two intermediate elements can provide a secondary support for the rechargeable battery pack for additional support for the rechargeable battery pack, e.g., in the event of accidental dropping of the hand-held power tool from a height of in particular more than one meter.

The rechargeable battery pack interface is preferably associated with a spring-decoupled contact holder to maintain electrical contact of the rechargeable battery pack at the rechargeable battery pack interface in the event of a shock pulse to the rechargeable battery pack in the direction of the at least two intermediate elements as the rechargeable battery pack moves from its mechanical receptacle into the primary and secondary support.

Destruction of the hand-held power tool by overstressing the rechargeable battery pack interface as a result of accidental dropping, e.g., from a height of in particular more than one meter, can thus reliably be prevented in an uncomplicated manner. The primary support is provided at the spring-decoupled contact holder and the secondary support is provided via the at least two intermediate elements at which any kinetic energy or impact energy is redirected.

The specified distance is preferably 2.5 mm ± 1 mm.

A suitable distance between the intermediate element and the rechargeable battery pack to implement a gradual redirection of force for the primary and secondary support can thus be provided in a simple manner.

The at least two intermediate elements preferably comprise polyurethane.

Thus, a suitable material which has good abrasion resistance can be provided in a simple and uncomplicated manner for the at least two intermediate elements.

The at least two intermediate elements preferably have a thickness between 2 mm and 8 mm. The at least two intermediate elements preferably each have a Shore Hardness between 60 and 70 Shore.

The at least two intermediate elements can thus be configured to be elastic but not damping, which enables the redirection of impact energy. A comparatively large abutment surface between the lateral surfaces can furthermore be achieved as well, as a result of which unevennesses can easily be compensated.

According to one embodiment, the at least two intermediate elements are attached to the housing via an adhesive connection.

The at least two intermediate elements can thus easily be attached to the housing after completion of the hand-held power tool, or as a retrofit to an existing hand-held power tool.

The at least two intermediate elements are preferably detachably disposed on the housing.

Therefore, if required, the at least two intermediate elements can be replaced in a simple and uncomplicated manner.

The housing preferably comprises a housing portion on which the at least two intermediate elements are disposed, wherein the housing portion is disposed at a specified angle to the rechargeable battery pack interface.

A suitable arrangement of the at least two intermediate elements in the region of the rechargeable battery pack interface to form the secondary support can thus easily be made possible.

When the rechargeable battery pack is installed at the rechargeable battery pack interface, the housing portion preferably comprises a lateral surface which is disposed such that it faces the rechargeable battery pack and the rechargeable battery pack comprises a lateral surface which is disposed such that it faces the housing portion and the specified distance is provided between the two lateral surfaces.

The specified distance for implementing a gradual redirection of force for the primary and secondary support can thus be provided in a simple and uncomplicated manner.

According to one embodiment, electronics of the hand-held power tool are disposed in the housing portion.

This enables reliable operation of the hand-held power tool, because the at least two intermediate elements can redirect impact energy that would otherwise act on the electronics in the event of accidental dropping of the hand-held power tool.

The housing portion is preferably comprised two housing half-shells and at least one intermediate element is attached to each housing half-shell.

Easy installation of the electronics and wiring associated with the electronics can thus be ensured in a simple manner. The at least two intermediate elements can furthermore be installed in the course of a preassembly.

### BRIEF DESCRIPTION OF THE DRAWINGS

The disclosure is explained in more detail in the following description with reference to design examples which are shown in the following drawings.

FIG. 1 is a side view of a hand-held power tool comprising a rechargeable battery pack and intermediate elements associated with the rechargeable battery pack in an impact on a first edge of the rechargeable battery pack,

FIG. 2 is a side view of the hand-held power tool comprising a rechargeable battery pack of FIG. 1 in an impact on a second edge of the rechargeable battery pack,

FIG. 3 is an enlarged view of a rechargeable battery pack interface associated with the hand-held power tool of FIG. 1 and FIG. 2 with the housing of the hand-held power tool open, and

FIG. 4 is a perspective view of a housing portion associated with the housing of the hand-held power tool of FIG. 1 to FIG. 3 with the intermediate elements.

### DETAILED DESCRIPTION

Elements having the same or a comparable function are provided with the same reference signs in the figures and are described in detail only once.

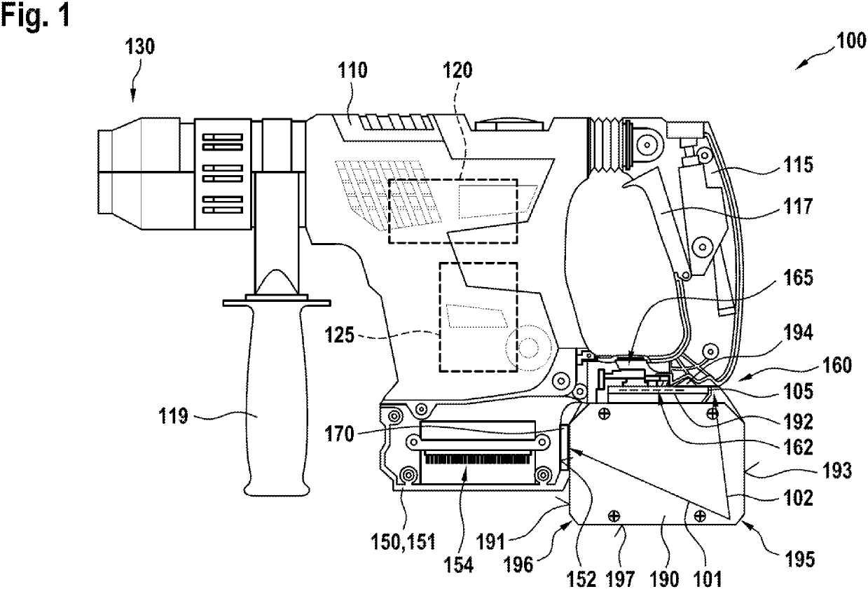

FIG. 1 shows an example of a hand-held power tool 100 comprising a housing 110, in which a drive unit for rotatably driving a tool holder 130 is preferably disposed. As can be seen, the tool holder 130 is illustratively configured to receive an insert tool and, in operation, rotates about an associated axis of rotation. An optional auxiliary handle 119 is furthermore disposed on the housing 110 in the region of the tool holder 130.

The drive unit in the shown design example illustratively comprises at least one drive motor 125 and a gearing 120. The drive motor 125 is preferably configured as an electronically commutated motor. The drive motor 125 can preferably be switched on and off via a manual switch 117, wherein the manual switch 117 is illustratively disposed on a handle 115 of the housing 110.

The hand-held power tool 100 furthermore preferably comprises a rechargeable battery pack interface 160 for placing a rechargeable battery pack 190 for supplying power to the drive motor 125. For this purpose, the rechargeable battery pack interface 160 illustratively comprises at least one, preferably two guide rails 162. The rechargeable battery pack 190 analogously likewise comprises at least one, preferably two guide rails 192. The rechargeable battery pack 190 is preferably disposed at the rechargeable battery pack interface 160 by sliding (in FIG. 1 illustratively from right to left). The guide rails 192 of the rechargeable battery pack 190 are thereby guided on the guide rails 162 of the hand-held power tool 100 or the rechargeable battery pack interface 160 of the hand-held power tool 100.

In the region of the guide rail 192, the rechargeable battery pack 190 preferably comprises a locking element 194. The rechargeable battery pack 190 furthermore comprises an (illustratively in FIG. 1) right and an (illustratively in FIG. 1) left lateral surface 193, 191 and two edges 195, 196. The edge 195 is illustratively disposed between the lateral surface 193 and a bottom surface 197 and the edge 196 is disposed between the lateral surface 191 and the bottom surface 197.

The housing 110 preferably comprises a housing portion 150. The housing portion 150 is disposed at a specified angle to the rechargeable battery pack interface 160. Illustratively, the specified angle is approximately 90 degrees. Electronics 154 of the hand-held power tool 100 are preferably disposed in the housing portion 150. According to one embodiment, at least the housing portion 150 is configured of two housing half-shells 151.

In the installed state of the rechargeable battery pack 190 at the rechargeable battery pack interface 160 shown in FIG. 1, the housing portion 150 comprises a lateral surface 152 which is disposed such that it faces the rechargeable battery pack 190. The lateral surface 191 of the rechargeable battery pack 190 is analogously disposed such that it faces the housing portion 150.

The rechargeable battery pack interface 160 preferably forms an electromechanical receptacle and guide for the rechargeable battery pack 190, wherein a stop in the guide rail 162 forms a primary support. On the one hand, the primary support forms a support for the rechargeable battery pack 190, e.g., in an impact of the rechargeable battery pack 190 fixed to the rechargeable battery pack interface 160 onto a surface as a result of in particular accidental dropping of the hand-held power tool 100 from a height of in particular more than one meter, and, on the other hand, it forms an arrangement of the rechargeable battery pack 190 in its disposed, in particular inserted, state at the rechargeable battery pack interface 160 during a working process. According to one embodiment, a spring-decoupled contact holder 165 is associated with the rechargeable battery pack interface 160 for this purpose. Such a spring-decoupled contact holder 165 is known from DE 10 2005 020 358 A1, which is hereby explicitly included in the present patent application. In the event of a shock pulse to the rechargeable battery pack 190 caused by the above-described impact on a surface as a result of dropping from a height of more than 1 m, the electrical contact between the rechargeable battery pack 190 and the contact holder 165 is maintained by the spring decoupling on the contact holder 165. Such a shock pulse can result from a fall of the hand-held power tool 100 and a corresponding impact to the rechargeable battery pack 190, for instance, or from a blow to the rechargeable battery pack 190 or the like.

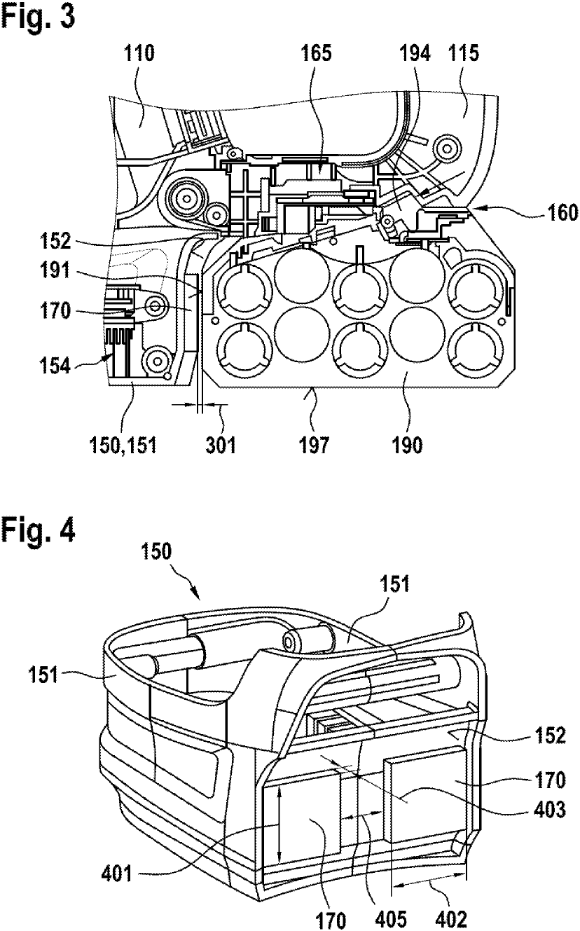

According to the disclosure, at least two intermediate elements 170 for forming a secondary support are disposed on the housing 110 in the region of the rechargeable battery pack interface 160. The at least two intermediate elements 170 are preferably disposed such that, in an unloaded state, e.g., during a working process in which the rechargeable battery pack 190 is not subjected to a force, a specified distance (301 in FIG. 3) is formed between the at least two intermediate elements 170 and a rechargeable battery pack 190 disposed at the rechargeable battery pack interface 160.

The at least two intermediate elements 170 are preferably disposed on the housing portion 150, in particular on the lateral surface 152 of the housing portion 150. According to one embodiment, at least the housing portion 150 is configured of two housing half-shells 151, wherein at least one intermediate element 170 is attached to each housing half-shell 151.

The specified distance (301 in FIG. 3) is preferably formed between the lateral surface 152 of the housing portion 150 and the lateral surface 191 of the rechargeable battery pack 190 which is disposed such that it faces the housing portion 150. The specified distance (301 in FIG. 3) preferably decreases in the event of a shock pulse to the rechargeable battery pack 190, e.g., the above-described impact on a surface as a result of accidental dropping from a height of in particular more than one meter, in the direction of the at least two intermediate elements 170. The secondary support is formed when the rechargeable battery pack 190 abuts the at least two intermediate elements 170.

The spring-decoupled contact holder 165 is in particular configured to maintain electrical contact of the rechargeable battery pack 190 at the rechargeable battery pack interface 160 in the event of a shock pulse to the rechargeable battery pack 190 as the rechargeable battery pack 190 moves from its mechanical receptacle into the primary and secondary support.

The at least two intermediate elements 170 preferably comprise polyurethane. Polyurethane provides good abrasion resistance and leaves no signs of wear when two components come into contact. The at least two intermediate elements 170 preferably have a thickness (403 in FIG. 4) between 2 mm and 8 mm. This preferably does not result in any damping, but merely in a redirection of impact energy. The at least two intermediate elements 170 furthermore preferably each have a Shore Hardness between 60 and 70 Shore.

According to one embodiment, the at least two intermediate elements 170 are attached to the housing 110 via an adhesive connection. The housing portions 150 preferably comprise an adhesive surface on their lateral surfaces 152. The at least two intermediate elements 170 are preferably detachably disposed on the housing 110.

When the hand-held power tool 100 falls from a height of in particular more than one meter and the hand-held power tool 100 impacts on the rechargeable battery pack 190 or on the edge 195, there is a weak point 105 in the region of the rechargeable battery pack interface 160. The weak point 105 is preferably located at the mechanical stop of the guide rails 162, illustratively at the right end thereof. An occurring kinetic energy or an impact energy is indicated with the arrows 101, 102. The impact energy is transmitted along the arrow 102 from the guide rail 192 to the guide rail 162 until the primary support comes into contact at the weak point 105. Elastic deformations occur at the weak point 105 and the specified distance (301 in FIG. 3) simultaneously decreases. The remaining impact energy is then passed on along the arrow 101 to the at least two intermediate elements 170 and directed into the housing portion 150. This process therefore acts in a progressive manner. Destruction at the weak point 105 of the guide rails 162 and the guide of the rechargeable battery pack 192 is thus prevented, because the impact energy is gradually distributed between the primary support and the secondary support on the housing portion 150. Redirection of the impact energy acting on the housing portion 150 preferably takes place at a sufficiently rigid lateral surface 152 of the housing portion 150, to which the at least two intermediate elements 170 are preferably glued. The electronics 154 are preferably fixed in the housing portion 150 at their own attachment points inside the housing portion 150. This results in a sufficiently large buffer zone between the lateral surface 152 and the electronics 154. The electronics 154 are protected from the redistribution of forces on the housing portion 150 by the buffer zone.

As an example, the hand-held power tool 100 is configured in FIG. 1 as a drill driver. However, the hand-held power tool 100 can also be configured as a hammer drill, for example, or an impact drill driver comprising a percussion mechanism. In a design of the hand-held power tool 100 as a hammer drill, the gearing 120 is configured as a spur gear. It should be noted, however, that the present disclosure is not limited to drill drivers, hammer drills or impact drill drivers, but can generally be used in hand-held power tools that comprise a housing portion corresponding to the above-described housing portion 150 with at least two intermediate elements 170 and a rechargeable battery pack 190. The heavier the hand-held power tool 100 is, the more important the redistribution of forces is. The hand-held power tool 100 preferably has a total weight greater than or equal to 4 kg.

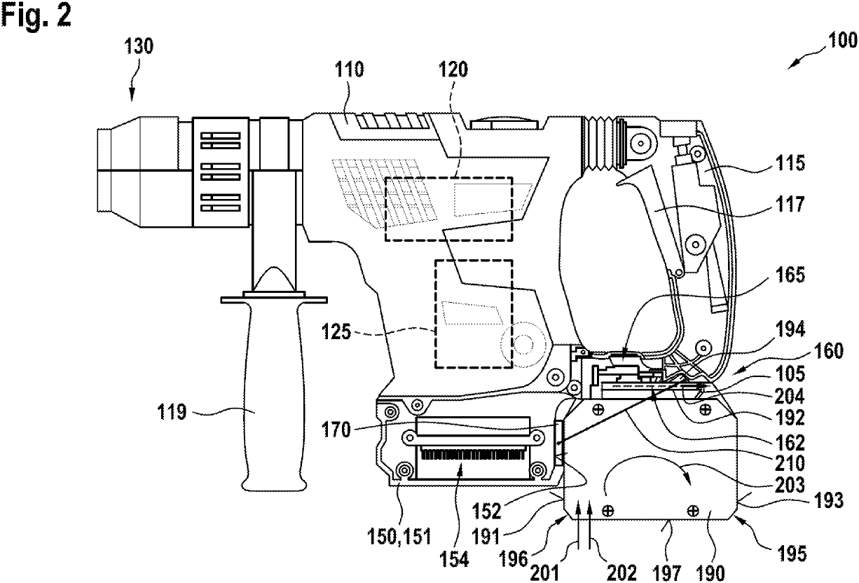

FIG. 2 shows the hand-held power tool 100 of FIG. 1 when the hand-held power tool 100 falls from a height of in particular more than one meter and the hand-held power tool 100 lands or impacts on the rechargeable battery pack 190 or on the edge 196. This results in impact energy in the direction of the arrows 201, 202, which produces a rotational movement of the rechargeable battery pack 190 along an arrow 203 or clockwise and directs the impact energy along an arrow 204 toward the weak point 105 on the guide rail 162. However, support, i.e., secondary support, is again provided by the at least two intermediate elements 170. When the rechargeable battery pack 190 rotates along the arrow 203, the rechargeable battery pack 190 is driven comparatively strongly out of the guide rails 162, 192. The secondary support creates a support triangle between the locking element 194 and the at least two intermediate elements 170 along the illustrative line 210. The support triangle reduces the rotation of the rechargeable battery pack 190. This slows the forced movement of the rechargeable battery pack 190 out of the guide rails 162, 192 and reduces the load on the weak point 105.

FIG. 3 shows the rechargeable battery pack interface 160 and the housing portion 150 of FIG. 1 and FIG. 2 in a resting state or an unloaded state. FIG. 3 illustrates a specified distance 301 formed between the lateral surface 152 of the housing portion 150 and the lateral surface 191 of the rechargeable battery pack 190 which is disposed such that it faces the housing portion 150. The two lateral surfaces 152, 191 are preferably disposed plane-parallel to one another, whereby the specified distance 301 is formed of the distance between the two lateral surfaces 152, 191. The specified distance 301 is preferably 2.5 mm ± 1 mm.

FIG. 4 shows the housing portion 150 of the housing 110 of the hand-held power tool of FIG. 1 to FIG. 3 with the preferably two housing half-shells 151. Each housing half-shell 151 is preferably provided with at least one intermediate element 170. The intermediate elements 170 are illustratively configured to be rectangular and have a height 401, a width 402 and a thickness 403. The illustrative two intermediate elements 170 are moreover spaced apart from one another by a distance 405.

According to one embodiment, the height 401 is 30 mm, the width 402 is 30 mm and the thickness 403 is between 2 mm and 8 mm. The thickness is preferably 5 mm. The distance 405 is 20 mm, for example.

It should be noted that the stated dimensions of the height 401, the width 402 and the distance 405 are merely exemplary in nature and should not be seen as a limitation of the present disclosure. It should furthermore be noted that the intermediate elements 170 can have any shape; e.g., round, oval, configured as a triangle or a polygon having more than four corners. The at least two intermediate elements 170 can likewise be configured with different shapes and dimensions. It is furthermore also possible that more than two intermediate elements 170 be provided.

What is claimed is:

1. A hand-held power tool, comprising:
a tool holder;
at least one drive motor configured to drive the tool holder;
a housing in which the at least one drive motor is disposed;
a rechargeable battery pack configured to supply power to the at least one drive motor;
a rechargeable battery pack interface configured to form a primary support for the rechargeable battery pack; and
at least two intermediate elements configured to form a secondary support for the rechargeable battery pack, the at least two intermediate elements being disposed on the housing in the region of the rechargeable battery pack interface,
wherein the at least two intermediate elements are disposed in such a way that a specified distance between the at least two intermediate elements and the rechargeable battery pack is provided which decreases in the direction of the at least two intermediate elements in the event of a shock pulse to the rechargeable battery pack, and
wherein the at least two intermediate elements form the secondary support when the rechargeable battery pack abuts the at least two intermediate elements.

2. The hand-held power tool according to claim 1, further comprising a spring-decoupled contact holder, wherein:
the rechargeable battery pack interface cooperates with the spring-decoupled contact holder so as to maintain electrical contact of the rechargeable battery pack at the rechargeable battery pack interface in the event of a shock pulse to the rechargeable battery pack in the direction of the at least two intermediate elements as the rechargeable battery pack moves from a mechanical receptacle into the primary support and the secondary support.

3. The hand-held power tool according to claim 1, wherein the specified distance is 2.5 mm ± 1 mm.

4. The hand-held power tool according to claim 1, wherein the at least two intermediate elements comprise polyurethane.

5. The hand-held power tool according to claim 4, wherein the at least two intermediate elements have a thickness of between 2 mm and 8 mm.

6. The hand-held power tool according to claim 4, wherein the at least two intermediate elements each have a Shore hardness of between 60 Shore and 70 Shore.

7. The hand-held power tool according to claim 1, wherein the at least two intermediate elements are attached to the housing via an adhesive connection.

8. The hand-held power tool according to claim 1, wherein the at least two intermediate elements are detachably disposed on the housing.

9. The hand-held power tool according to claim 1, wherein:
the housing includes a housing portion on which the at least two intermediate elements are disposed, and
the housing portion is disposed at a specified angle in relation to the rechargeable battery pack interface.

10. The hand-held power tool according to claim 9, wherein:
the rechargeable battery pack is installed at the rechargeable battery pack interface,
the housing portion includes a first lateral surface which is disposed such that it faces the rechargeable battery pack,
the rechargeable battery pack includes a second lateral surface which is disposed such that it faces the housing portion, and
the specified distance is provided between the first lateral surface and the second lateral surface.

11. The hand-held power tool according to claim 9, further comprising electronics that are disposed in the housing portion.

12. The hand-held power tool claim 9, wherein:
the housing portion includes two housing half-shells, and
at least one of the at least two intermediate elements is attached to each of the two housing half-shells.
